(19) United States
(12) Patent Application Publication
(10) Pub. No.: US 2025/0008311 A1
(43) Pub. Date: Jan. 2, 2025

(54) EMERGENCY LOCATING SYSTEM

(71) Applicant: Isaac Carrillo, Fontana, CA (US)

(72) Inventor: Isaac Carrillo, Fontana, CA (US)

(21) Appl. No.: 18/214,926

(22) Filed: Jun. 27, 2023

(51) Int. Cl. H04W 4/90; H04W 4/029

(52) U.S. Cl. CPC H04W 4/90; H04W 4/029

(57) ABSTRACT

An emergency locating system for remotely locating an individual in the event of an emergency includes a housing and a strap for attaching the housing to a wrist of an individual. A time is displayed on a display screen mounted to the housing. A global positioning system module is provided for determining a location of the individual, and a transceiver is provided for transmitting the location of the individual to a remote electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to emergency locating systems and more particularly pertains to a new emergency locating system for remotely locating an individual in the event of an emergency.

### (2) Description of Related Art Including Information Disclosed Under 37 CFR 1.97 and 1.98

The prior art described myriad devices which are worn on a wrist of an individual and which notify a remote electronic device of a location of the individual. However, the prior art does not disclose a wrist worn tracking device that comprises a processor configured to keep time, a display screen for displaying the time, a global positioning system module, and an emergency communications system which allows caregivers to monitor the location of the individual.

### BRIEF SUMMARY OF THE INVENTION

An embodiment of the disclosure meets the needs presented above by generally comprising a housing with a top wall, a bottom wall, and a perimeter wall, wherein the perimeter wall is coupled to and extending between the top wall and the bottom wall. A strap is coupled to and forms a closed loop with the housing. The closed loop has a size such that the closed loop is configured for receiving a wrist of an individual. A processor is mounted in the housing. A display screen is mounted to the top wall of the housing and is in communication with the processor. The processor is programmed to cause the display screen to display a time. A global positioning system (GPS) module is in communication with the processor, the GPS module is configured for communicating a location signal indicative of a location of the individual to the processor. A transceiver is in communication with the processor, and a remote electronic device in communication with the transceiver. The processor is programmed to selectively cause the transceiver to transmit the location signal to the remote electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of an emergency locating system according to an embodiment of the disclosure.

FIG. 2 is a top view of an embodiment of the disclosure.

FIG. 3 is a front view of an embodiment of the disclosure.

FIG. 4 is a back view of an embodiment of the disclosure.

FIG. 5 is a bottom view of an embodiment of the disclosure.

FIG. 6 is a block diagram of an embodiment of the disclosure.

### DETAILED DESCRIPTION OF THE INVENTION

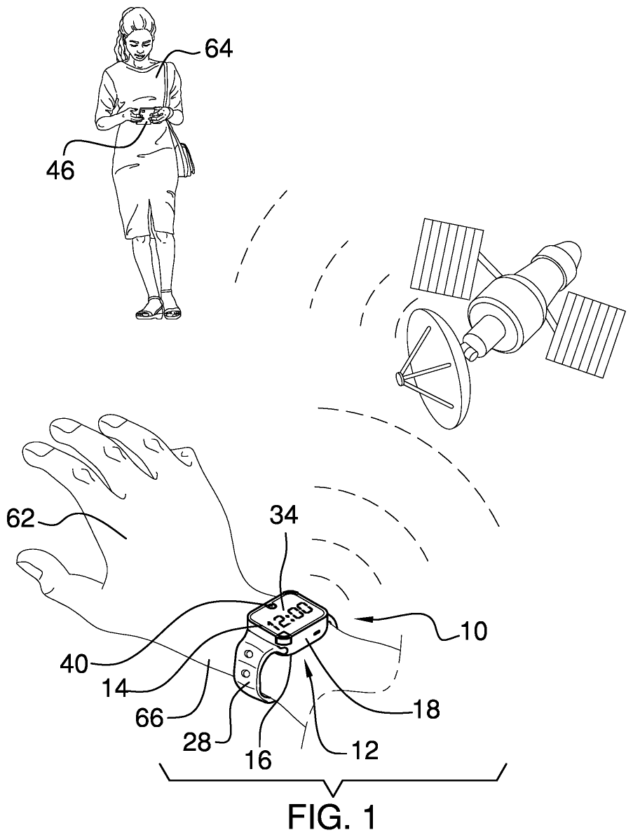

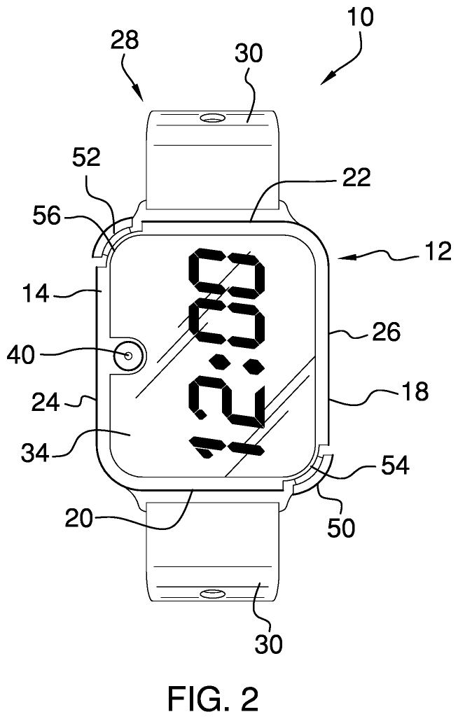

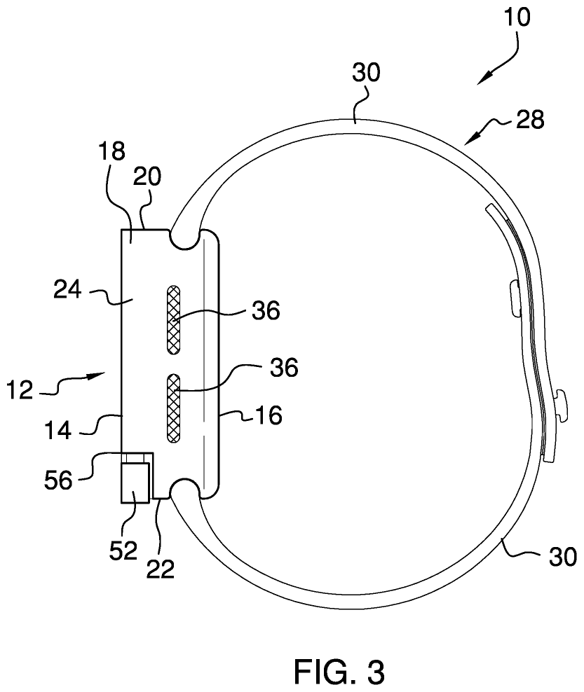

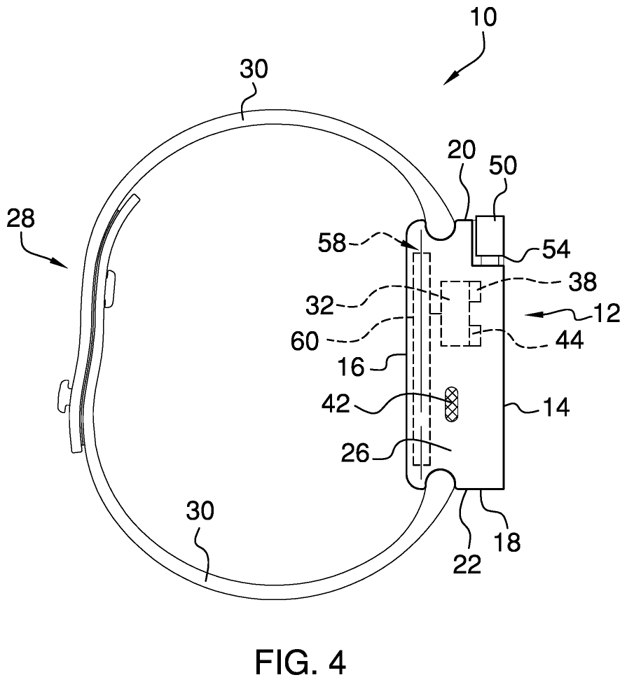

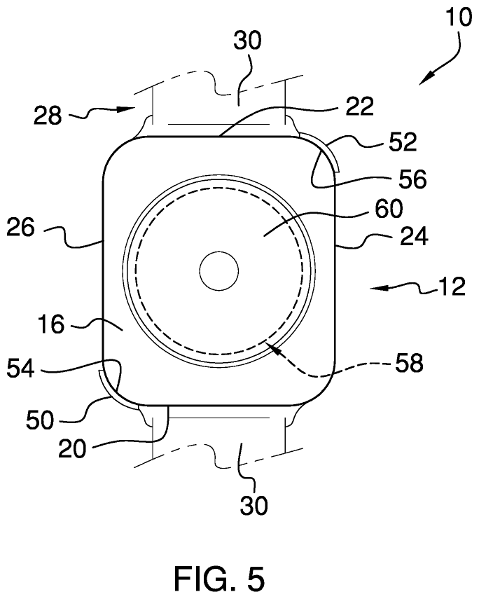

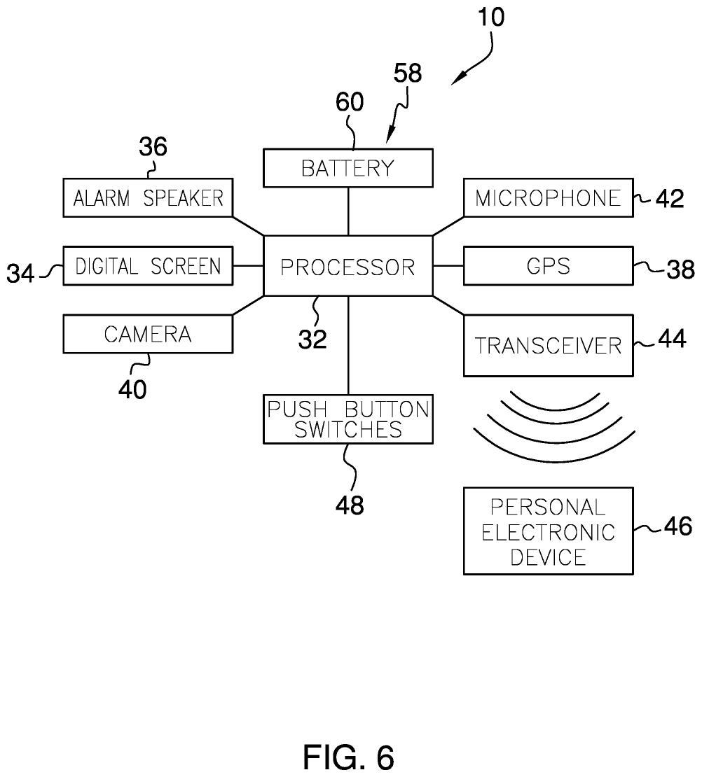

With reference now to the drawings, and in particular to FIGS. 1 through 6 thereof, a new emergency locating system embodying the principles and concepts of an embodiment of the disclosure and generally designated by the reference numeral 10 will be described.

As best illustrated in FIGS. 1 through 6, the emergency locating system 10 generally comprises a housing 12 with a top wall 14, a bottom wall 16, and a perimeter wall 18. The perimeter wall 18 is coupled to and extends between the top wall 14 and the bottom wall 16. The perimeter wall 18 comprises a first section 20 and a second section 22 positioned opposite each other. The perimeter wall 18 also comprises a third section 24 and a fourth section 26 positioned opposite each other and being coupled to and extending between the first section 20 and the second section 22. A strap 28 is coupled to and forms a closed loop with the housing 12. The closed loop has a size such that the closed loop is configured for receiving a wrist 66 of an individual 62. The strap 28 has a break therein defining a pair of strap segments 30. The pair of strap segments 30 are releasably couplable to each other via a snap connection but may be connectable by a buckle, clasp, hook-and-loop fastener, or the like. The strap 28 is coupled to and extends between the first section 20 and the second section 22 of the perimeter wall 18.

A processor 32 is mounted in the housing 12. A display screen 34 is mounted to the top wall 14 of the housing 12 and is in communication with the processor 32, which is programmed to cause the display screen 34 to display a time. A sound emitter 36 is mounted to the housing 12 and is in communication with the processor 32. The processor 32 is programmed to selectively cause the sound emitter 36 to emit an audible alarm. The sound emitter 36 is positioned on the third section 24 of the perimeter wall 18. A global positioning system (GPS) module 38 is in communication with the processor 32 and is configured for communicating a location signal indicative of a location of the individual 62 to the processor 32. A camera 40 is mounted to the housing 12 and is in communication with the processor 32. the processor 32 is programmed to selectively cause the camera 40 to capture images. The camera 40 is positioned on the top wall 14 adjacent to the third section 24 of the perimeter wall 18. A microphone 42 is mounted to the housing 12 and is in communication with the processor 32. The processor 32 is programmed to selectively cause the microphone 42 to capture an audio signal. The microphone 42 is positioned on the fourth section 26 of the perimeter wall 18. A transceiver 44 is in communication with the processor 32, and a remote electronic device 46 in communication with the transceiver 44. The processor 32 is programmed to selectively cause the transceiver 44 to transmit the location signal, the images, and the audio signal to the remote electronic device 46.

An input 48 is in communication with the processor 32 to control the processor 32. The input 48 comprises a first button 50 positioned on a first corner 54 of the perimeter wall 18 positioned between the first section 20 and the fourth section 26 and a second button 52 positioned on a second corner 56 of the perimeter wall 18 positioned between the second section 22 and the third section 24. The input 48 is actuatable to perform an emergency alert function wherein the processor 32 causes the sound emitter 36 to sound the audible alarm and causes the transceiver 44 to transmit the location signal to the remote electronic device 46. To cause the processor 32 to perform the emergency alert function, the first button 50 and the second button 52 are simultaneously actuated, held for a first predetermined period of time, and simultaneously released. The first predetermined period of time may be, for example, 3.0 seconds.

The input 48 is also actuatable to perform a capture-and-send function wherein the processor 32 causes the camera 40 to capture an image and causes the transceiver 44 to transmit the image to the remote electronic device 46. To cause the processor 32 to perform the capture-and-send function, the first button 50 and the second button 52 are simultaneously actuated twice consecutively to initiate a capture mode of the processor 32 and simultaneously once while the processor 32 is in the capture mode to capture and transmit an image at the instant of actuation. The input 48 is actuatable to perform a chat function wherein the processor 32 causes the transceiver 44 to transmit the images and the audio signal to the remote electronic device 46, causes the display screen 34 to display a video stream received from the remote electronic device 46, and causes the sound emitter 36 to emit an audio stream received from the remote electronic device 46. To cause the processor 32 to perform the chat function, the second button 52 is actuated, held for a second predetermined period of time, and released. The second predetermined period of time may be equivalent to the first predetermined period of time.

A power supply 58 is electrically coupled to the processor 32 and mounted in the housing 12. The power supply 58 comprises a battery 60, which may be accessible through a door or other conventional means for replacement. The housing 12 may also have a solar cell mounted thereon which converts solar energy into electricity for charging the battery 60.

In use, the housing 12 is attached to the wrist 66 of the individual 62, who may be a child or other person under the care of a caregiver 64. The caregiver 64 uses the remote electronic device 46 to monitor the individual 62. The individual 62 may operate the input 48 as described more fully above to perform the various functions to communicate with the caregiver 64 and alert the caregiver 64 to emergencies. In some cases, the remote electronic device 46 may be used by a law enforcement agency to monitor the individual 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency locating system comprising:
a housing having a top wall, a bottom wall, and a perimeter wall, the perimeter wall being coupled to and extending between the top wall and the bottom wall;
a strap being coupled to and forming a closed loop with the housing, the closed loop having a size such that the closed loop is configured for receiving a wrist of an individual;
a processor mounted in the housing;
a display screen being mounted to the top wall of the housing and being in communication with the processor, the processor being programmed to cause the display screen to display a time;
a global positioning system (GPS) module being in communication with the processor, the GPS module being configured for communicating a location signal indicative of a location of the individual to the processor;
a transceiver being in communication with the processor;
a remote electronic device in communication with the transceiver; and
the processor being programmed to selectively cause the transceiver to transmit the location signal to the remote electronic device.

2. The system of claim 1, wherein the strap has a break therein defining a pair of strap segments, the pair of strap segments being releasably couplable to each other.

3. The system of claim 2, wherein the pair of segments are releasably couplable to each other via a snap connection.

4. The system of claim 1, further comprising:
a sound emitter being mounted to the housing and being in communication with the processor, the processor being programmed to selectively cause the sound emitter to emit an audible alarm; and
an input being in communication with the processor to control the processor, the input being actuatable to perform an emergency alert function wherein the processor causes the sound emitter to sound the audible alarm and causes the transceiver to transmit the location signal to the remote electronic device.

5. The system of claim 1, further comprising a camera being mounted to the housing and being in communication with the processor, the processor being programmed to selectively cause the camera to capture images.

6. The system of claim 5, wherein the processor is programmed to selectively cause the transceiver to transmit the images to the remote electronic device.

7. The system of claim 6, further comprising an input being in communication with the processor to control the processor, the input being actuatable to perform a capture-and-send function wherein the processor causes the camera to capture an image and causes the transceiver to transmit the image to the remote electronic device.

8. The system of claim 1, further comprising a microphone being mounted to the housing and being in communication with the processor, the processor being programmed to selectively cause the microphone to capture an audio signal.

9. The system of claim 8, wherein the processor is programmed to selectively cause the transceiver to transmit the audio signal to the remote electronic device.

10. The system of claim 9, further comprising:
a sound emitter being mounted to the housing and being in communication with the processor;
a camera being mounted to the housing and being in communication with the processor, the processor being programmed to selectively cause the camera to capture images; and
an input being in communication with the processor to control the processor, the input being actuatable to perform a chat function wherein the processor causes the transceiver to transmit the images and the audio signal to the remote electronic device, causes the display screen to display a video stream received from the remote electronic device, and causes the sound emitter to emit an audio stream received from the remote electronic device.

11. The system of claim 1, further comprising an input being in communication with the processor to control the processor wherein the perimeter wall comprises a first section and a second section being positioned opposite each other, the perimeter wall comprising a third section and a fourth section being positioned opposite each other, each of the third section and the fourth section being coupled to and extending between the first section and the second section.

12. The system of claim 11, wherein the strap is coupled to and extends between the first section and the second section of the perimeter wall.

13. The system of claim 1, further comprising a power supply being electrically coupled to the processor.

14. The system of claim 13, wherein the power supply comprises a battery.

15. An emergency locating system comprising:
a housing having a top wall, a bottom wall, and a perimeter wall, the perimeter wall being coupled to and extending between the top wall and the bottom wall, the perimeter wall comprising a first section and a second section being positioned opposite each other, the perimeter wall comprising a third section and a fourth section being positioned opposite each other, each of the third section and the fourth section being coupled to and extending between the first section and the second section;
a strap being coupled to and forming a closed loop with the housing, the closed loop having a size such that the closed loop is configured for receiving a wrist of an individual, the strap having a break therein defining a pair of strap segments, the pair of strap segments being releasably couplable to each other via a snap connection, the strap being coupled to and extending between the first section and the second section of the perimeter wall;
a processor mounted in the housing;
a display screen being mounted to the top wall of the housing and being in communication with the processor, the processor being programmed to cause the display screen to display a time;
a sound emitter being mounted to the housing and being in communication with the processor, the processor being programmed to selectively cause the sound emitter to emit an audible alarm, the sound emitter being positioned on the third section of the perimeter wall;
a global positioning system (GPS) module being in communication with the processor, the GPS module being configured for communicating a location signal indicative of a location of the individual to the processor;
a camera being mounted to the housing and being in communication with the processor, the processor being programmed to selectively cause the camera to capture images, the camera being positioned on the top wall adjacent to the third section of the perimeter wall;
a microphone being mounted to the housing and being in communication with the processor, the processor being programmed to selectively cause the microphone to capture an audio signal, the microphone being positioned on the fourth section of the perimeter wall;
a transceiver being in communication with the processor;
a remote electronic device in communication with the transceiver;
the processor being programmed to selectively cause the transceiver to transmit the location signal to the remote electronic device, the processor being programmed to selectively cause the transceiver to transmit the images to the remote electronic device, the processor being programmed to selectively cause the transceiver to transmit the audio signal to the remote electronic device;
an input being in communication with the processor to control the processor, the input being actuatable to perform an emergency alert function wherein the processor causes the sound emitter to sound the audible alarm and causes the transceiver to transmit the location signal to the remote electronic device, the input being actuatable to perform a capture-and-send function wherein the processor causes the camera to capture an image and causes the transceiver to transmit the image to the remote electronic device, the input being actuatable to perform a chat function wherein the processor causes the transceiver to transmit the images and the audio signal to the remote electronic device, causes the display screen to display a video stream received from the remote electronic device, and causes the sound emitter to emit an audio stream received from the remote electronic device, the input comprising a first button positioned on a first corner of the perimeter wall positioned between the first section and the fourth section and a second button positioned on a second corner of the perimeter wall positioned between the second section and the third section; and
a power supply being electrically coupled to the processor, the power supply comprising a battery.
